(19) United States
(12) Patent Application Publication
(10) Pub. No.: US 2013/0014985 A1
(43) Pub. Date: Jan. 17, 2013

(54) Ceiling Deployable Electric and Data Ports Module

(71) Applicant: Vincent M. Ferrara, Richmond Hill, NY (US)

(72) Inventor: Vincent M. Ferrara, Richmond Hill, NY (US)

(21) Appl. No.: 13/181,317

(22) Filed: Jul. 12, 2011

(51) Int. Cl. H02G 3/18

(52) U.S. Cl. 174/491

(57) ABSTRACT

A concealed power/network module that can be lowered or raised from a ceiling via key switch or remote control having a weighted base with a canister providing a plurality of data and networking ports having a motorized pulley with spooled, tensioned lengths of wiring and network cables to raise and lower the canister without slack. Additionally the device has deployable support bars for stabilizing the device in a ceiling panel securely while not in use.

### BACKGROUND OF THE INVENTION

1. Field of the Invention

The present invention relates generally to electrical and data connections and, more specifically, to a power/network module for offices suspended from a ceiling mounted housing having a motorized pulley with a load bearing cable attached to a canister that may be raised or lowered via a key switch or remote control. Spooled, tensioned lengths of wiring and network cables are provided originating from the upper concealed ceiling portion of the device while terminating in the canister ports to provide a neat and slack free connection from the ceiling to desk, table or floor. Additionally provided for are connections for fixedly mounting the device to a ceiling or flush mounted to a suspended ceiling.

2. Description of the Prior Art

There are other ceiling deployable devices designed for connection services while these devices may be suitable for the purposes for which they were designed, they would not be as suitable for the purposes of the present invention, as hereinafter described.

### SUMMARY OF THE PRESENT INVENTION

A primary object of the present invention is to provide a concealed power/network module that can be lowered or raised from a ceiling via key switch or remote control.

Another object of the present invention is to provide a concealed power/network module that can be lowered or raised from a ceiling having a weight on the bottom of the canister to provide stable base for the canister when deployed.

Yet another object of the present invention is to provide a concealed power/network module that can be lowered or raised from a ceiling, providing a canister with connection and ports for electric, data, cable, networking and any other commonly used office connection.

Still yet another object of the present invention is to provide a concealed power/network module that can be lowered or raised from a ceiling via remote control, having a motorized pulley with a spooled tensioned length of electrical wiring and/or network cable are provided in the originating in the upper concealed ceiling portion of the device while terminating in the canister ports to provide a neat and slack free connection from the ceiling to desk, table or floor

Another object of the present invention is to provide a concealed power/network module that can be lowered or raised from a ceiling via remote control having deployable support bars for stabilizing the device in a ceiling panel securely while not in use.

Yet another object of the present invention is to provide a concealed power/network module that can be lowered or raised from a ceiling via remote control adaptable to a fixed or drop panel ceiling.

Additional objects of the present invention will appear as the description proceeds.

The present invention overcomes the shortcomings of the prior art by providing a concealed power/network module that can be lowered or raised from a ceiling via key switch or remote control having a weighted base with a canister providing a plurality of data and networking ports having a motorized pulley with spooled, tensioned lengths of wiring and network cables to raise and lower the canister without slack. Additionally the device has deployable support bars for stabilizing the device in a ceiling panel securely while not in use.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of prior art.

FIG. 2 is an illustrative view of the power/network module of the present invention in a retracted concealed position.

FIG. 3 is an illustrative view of the power/network module of the present invention deploying using a remote control.

FIG. 4 is an illustrative view of the power/network module of the present invention deployed to a desk.

FIG. 5 is an illustrative view of the power/network module of the present invention deployed using a key switch.

FIG. 6 is an illustrative view of the power/network module of the present invention deployed to a desk.

FIG. 7 is a perspective view of the deployable power/network module of the present invention.

FIG. 8 is a perspective view of the present invention.

FIG. 9 is an illustrative view of the power/network components of the present invention.

FIG. 10 is an illustrative view of the power/network components of the present invention in use.

FIG. 11 is a perspective view of an additional element of the present invention.

FIG. 12 is a sectional view of an embodiment of the power network module housing of the present invention.

FIG. 13 is a sectional view of an additional element of the present invention.

FIG. 14 is an illustrative view of the power/network components of the present invention in use. Shown is the power/network module comprising

### DESCRIPTION OF THE REFERENCED NUMERALS

Turning now descriptively to the drawings, in which similar reference characters denote similar elements throughout the several views, the figures illustrate the Ceiling Deployable Electric/Data Port Module System of the present invention. With regard to the reference numerals used, the following numbering is used throughout the various drawing figures.
10 Ceiling Deployable Electric/Network Port Module System of the present invention
12 prior art
14 electrical cord
16 data/network cable
18 module housing
20 suspended ceiling
22 high hat lighting fixture
24 key switch
26 hand held wireless remote control
28 user
30 motorized cable bundle
32 ceiling aperture
34 key switch
36 power receptacle
38 data/network port
40 weighted base of 18
42 ceiling plate of 18
44 central column of 18
46 motorized central steel cable
48 reversible motor
50 central steel cable spool
52 data/network spring tension spool
54 electrical spring tension spool
56 data/network feeder cable
58 electrical feeder wire
60 fixed ceiling
62 spreader bar
64 kill switch
66 receiver of 48
68 electrical switch

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

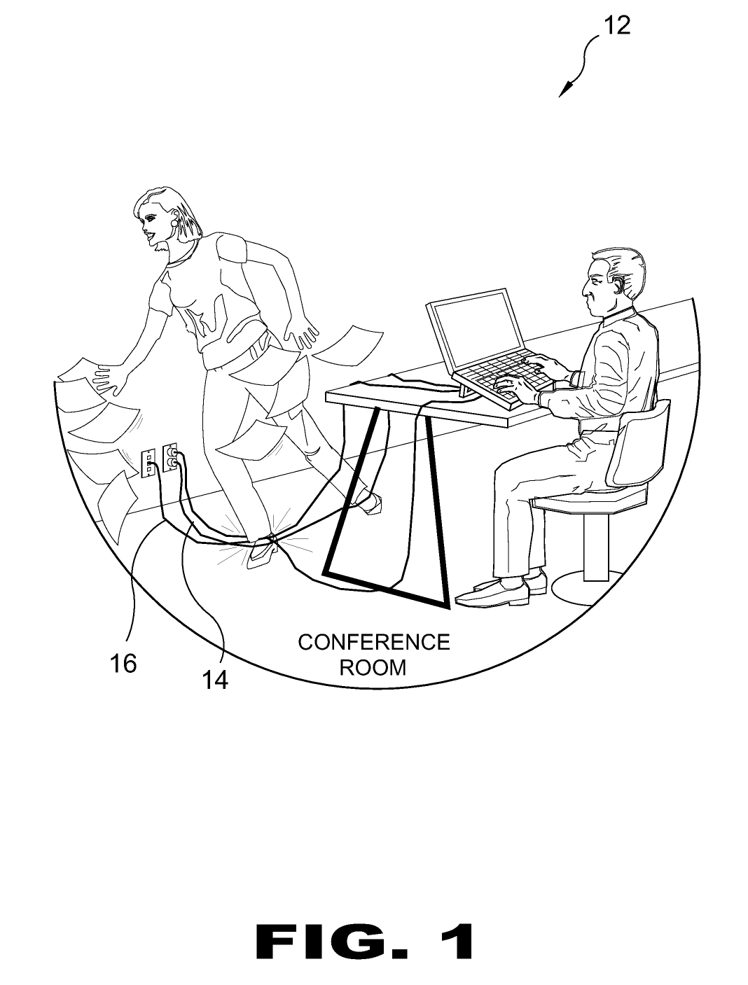

FIG. 1 is an illustrative view of prior art 12. Currently, electrical cords 14 and internet cables 16 cause a potential tripping hazard due to the way they are draped across tables and strung along the floor to connect to a service outlet. The present invention overcomes this problem by providing a concealed power/network receptacle module for offices and conference rooms that deploys from a ceiling module.

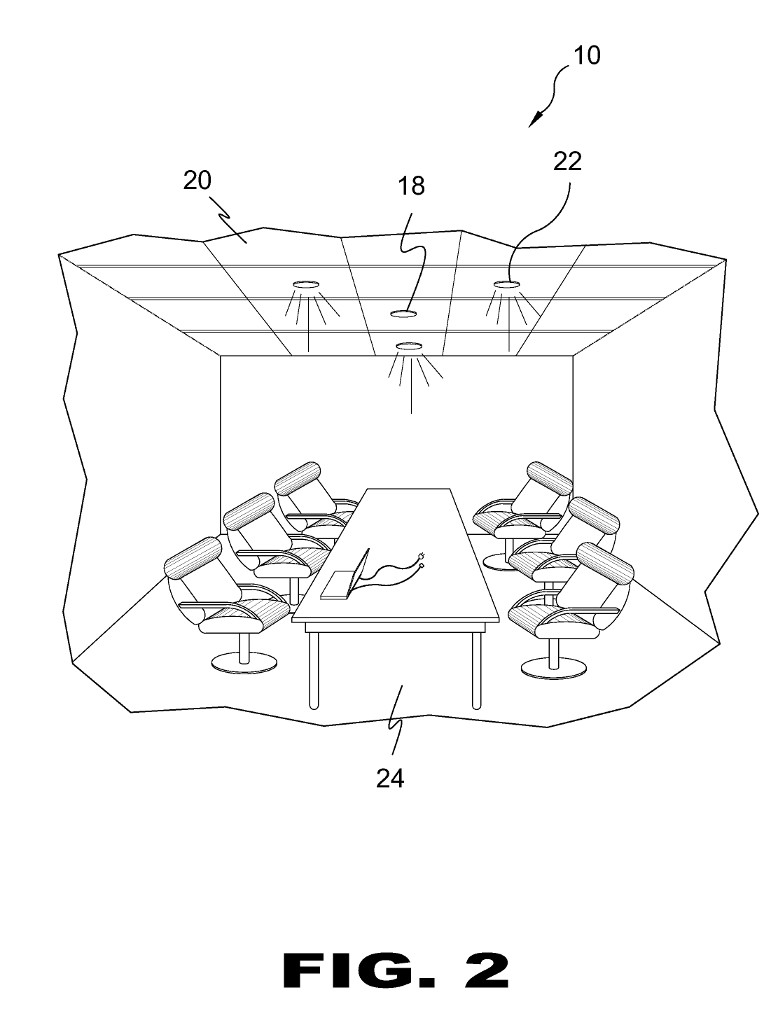

FIG. 2 is an illustrative view of the ceiling deployable electric and data ports module system 10 of the present invention in a retracted concealed position. Shown is an embodiment of the power/network module housing 18 positioned within and supported by a suspended ceiling 20. As illustrated, the power/network module 18 is of similar appearance and size to a high hat lighting fixture 22 and therefore concealed when retracted. The present invention envisions that the module housing 18 can be affixed to any ceiling whether home, office or conference room 24 so that electrical wiring and associated receptacle(s) and optional network cables and associated receptacle(s) can be retracted out of sight eliminating the aforementioned dangers of ground based wiring and adding to the aesthetic appearance of the room.

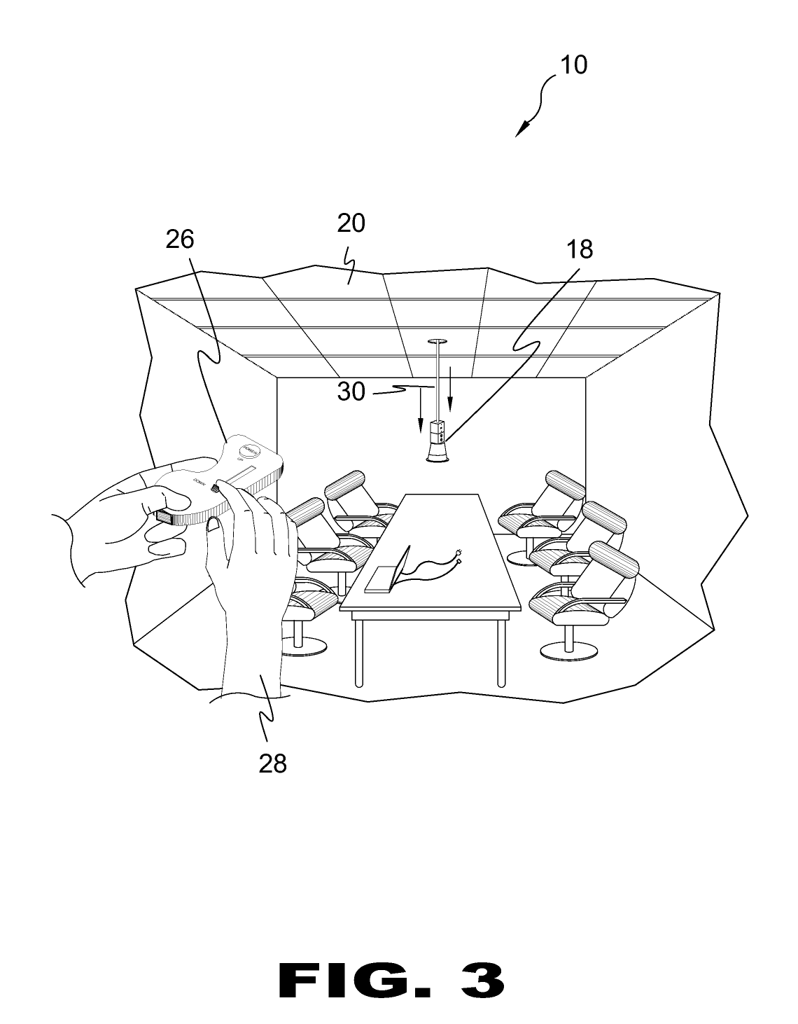

FIG. 3 is an illustrative view of the ceiling deployable electric and data ports module system 10 of the present invention deploying using a remote control 26 operated by the user 28. Shown is the power/network module housing 18 deploying from a motorized cable bundle 30 by remote control 26. The power/network module housing 18 has a weighted base so when deployed travels in vertical fashion to a support structure, such as a desk, and since it basically deploys through gravity and is tethered by pliable cable it can be relocated to any desired location.

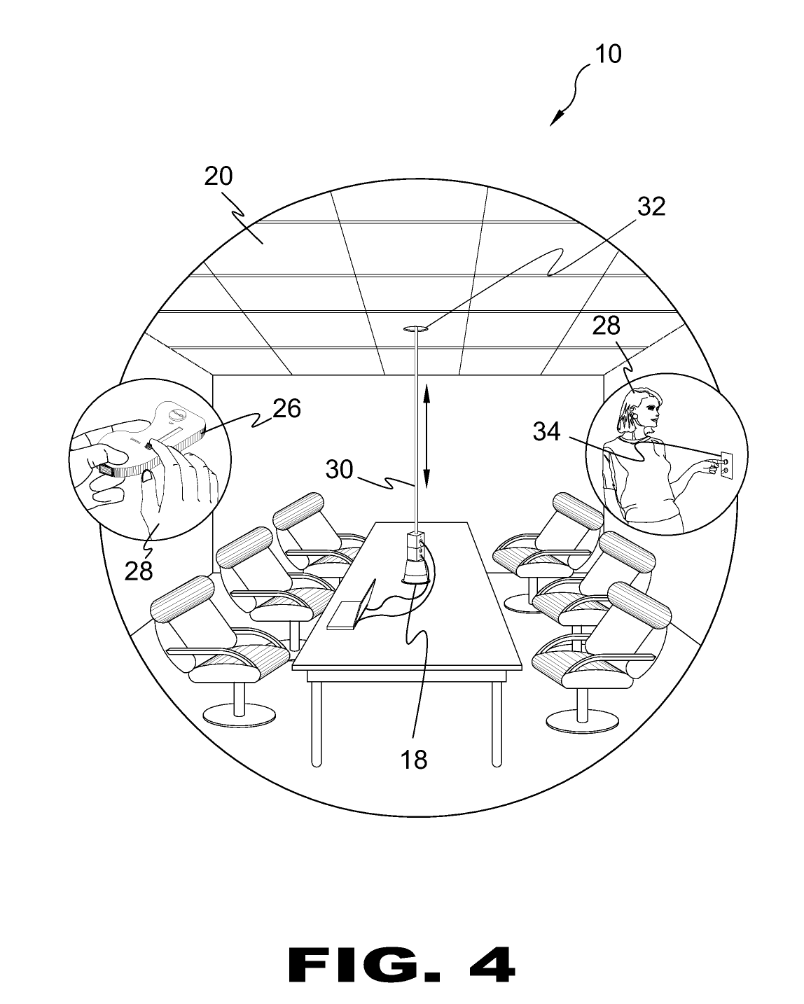

FIG. 4 is an illustrative view of the ceiling deployable electric and data ports module system 10 of the present invention with the module housing 18 deployed to a desk. Shown is the power/network module housing 18 deployed with a cable bundle 30 from an aperture 32 in the drop ceiling 20 by means of a provided wall mounted key switch 34 or by a provided remote control 26 so that users 28 can connect electronic equipment to the power/network module housing 18. The present invention optionally provides network connection receptacles. The power/network module 18 has a weighted base so when deployed it travels in vertical fashion to a support structure, such as a desk, and since it basically deploys through gravity and is tethered by pliable steel cable it then can be relocated to any desired location as desired.

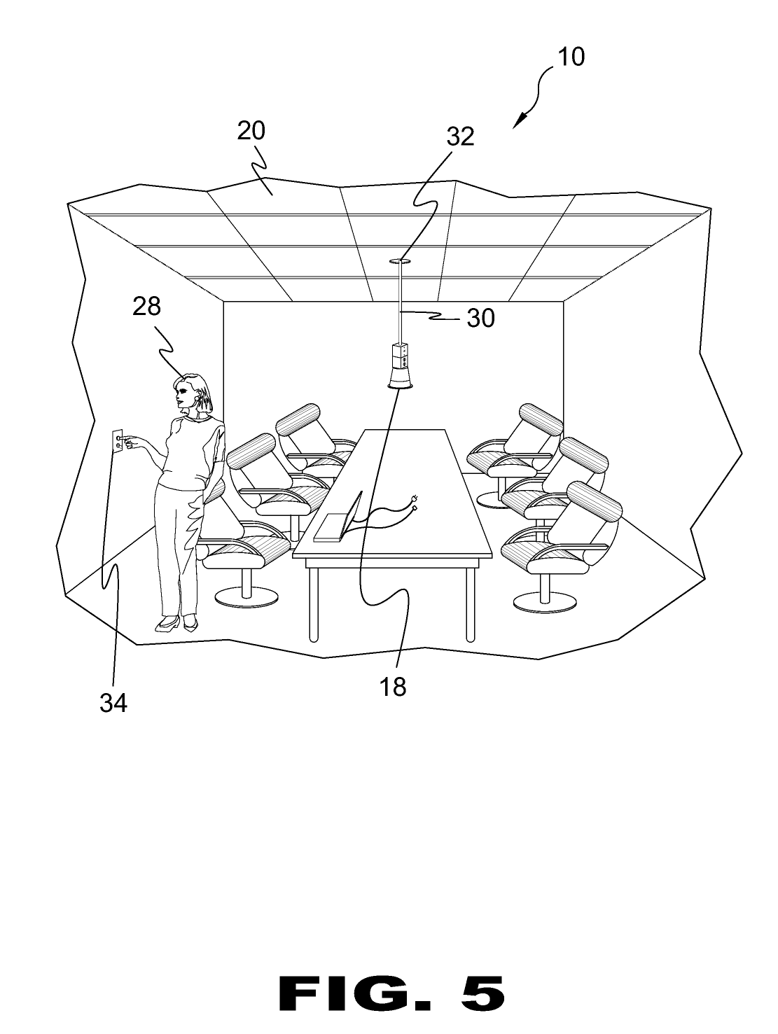

FIG. 5 is an illustrative view of the ceiling deployable electric and data ports module system 10 of the present invention with the module housing 18 being deployed to a desk. Shown is the power/network module housing 18 being deployed with a cable bundle 30 from an aperture 32 in the drop ceiling 20 by means of a provided wall mounted key switch 34 so that users 28 can connect electronic equipment to the power/network module housing 18.

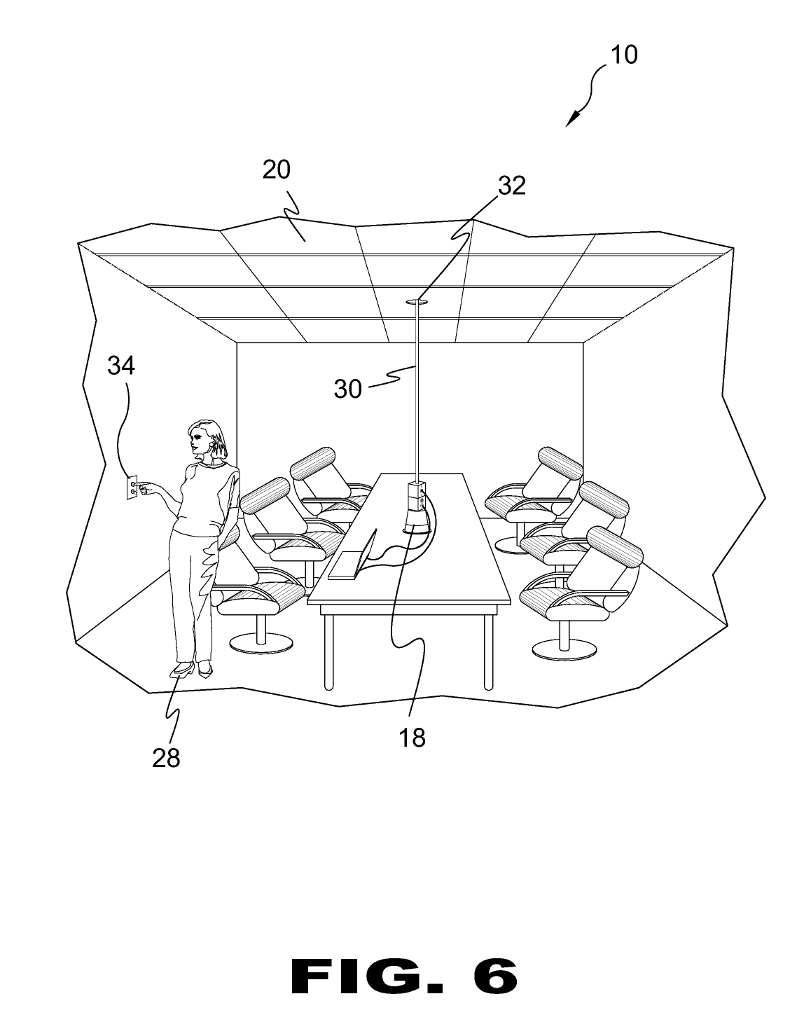

FIG. 6 is an illustrative view of the ceiling deployable electric and data ports module system 10 of the present invention deployed to a desk. Shown is the power/network module housing 18 deployed with a cable bundle 30 from an aperture 32 in the drop ceiling 20 by means of a provided wall mounted key switch 34 so that users 28 can connect electronic equipment to the power/network module housing 18.

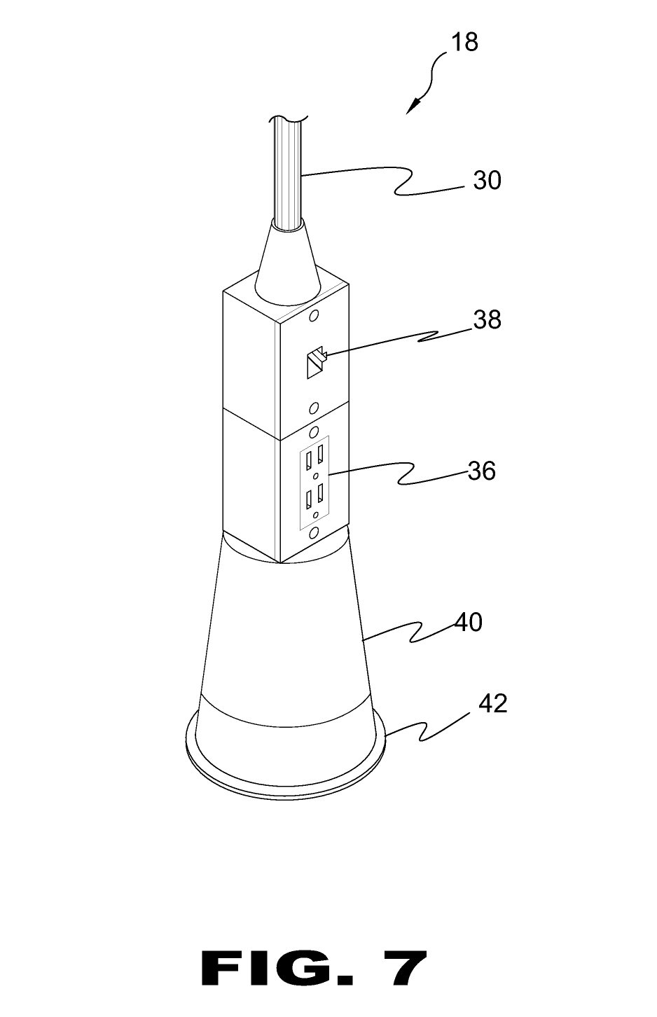

FIG. 7 is a perspective view of the deployable power/network module housing 18 of the present invention. Shown is the deployable power/network module housing 18 comprising power receptacles 36 and network/data connection ports 38 in electrical communication with a source service. The housing 18 includes a conical weighted base 40 and ceiling plate 42. Also depicted is a cable wrap 30 having a line, preferably steel cable, attached to a motorized spool with the electrical and network cables each attached to tensioned spools to aid in retracting them.

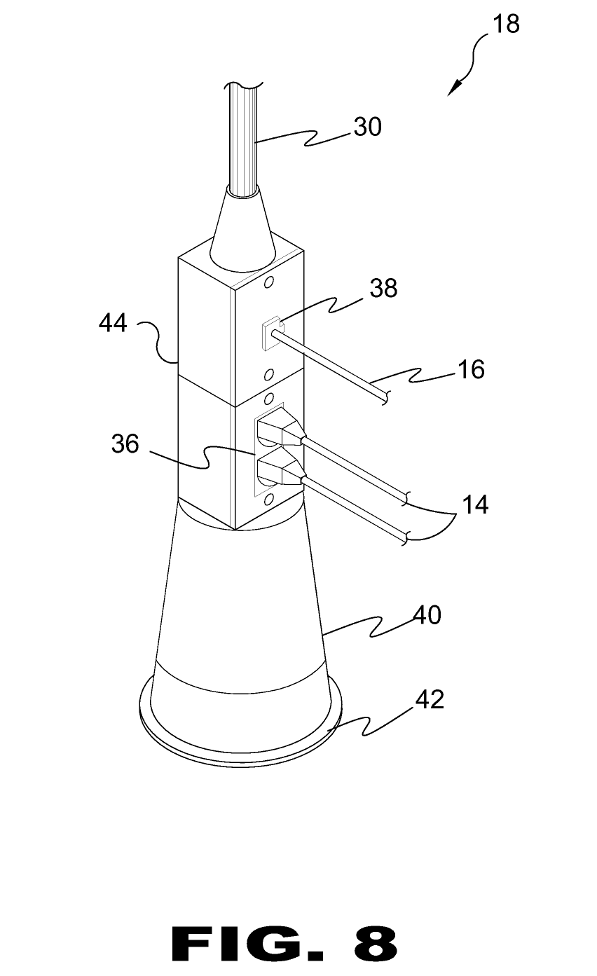

FIG. 8 is a perspective view of the power/network module housing 18 of the present invention. Shown is a detailed perspective of the present inventions conceal able power/network module housing 18 having a weighted base 40 and ceiling plate 42 to conceal it and to rest on when deployed. A central column 44 includes a plurality of data/network ports 38 and electrical power receptacles 36 surrounding it's periphery for easy access and connection to a computer phone or other office equipment. Also depicted are the network/data cables 16 and electric power cords 14 inserted into their respective ports and receptacles.

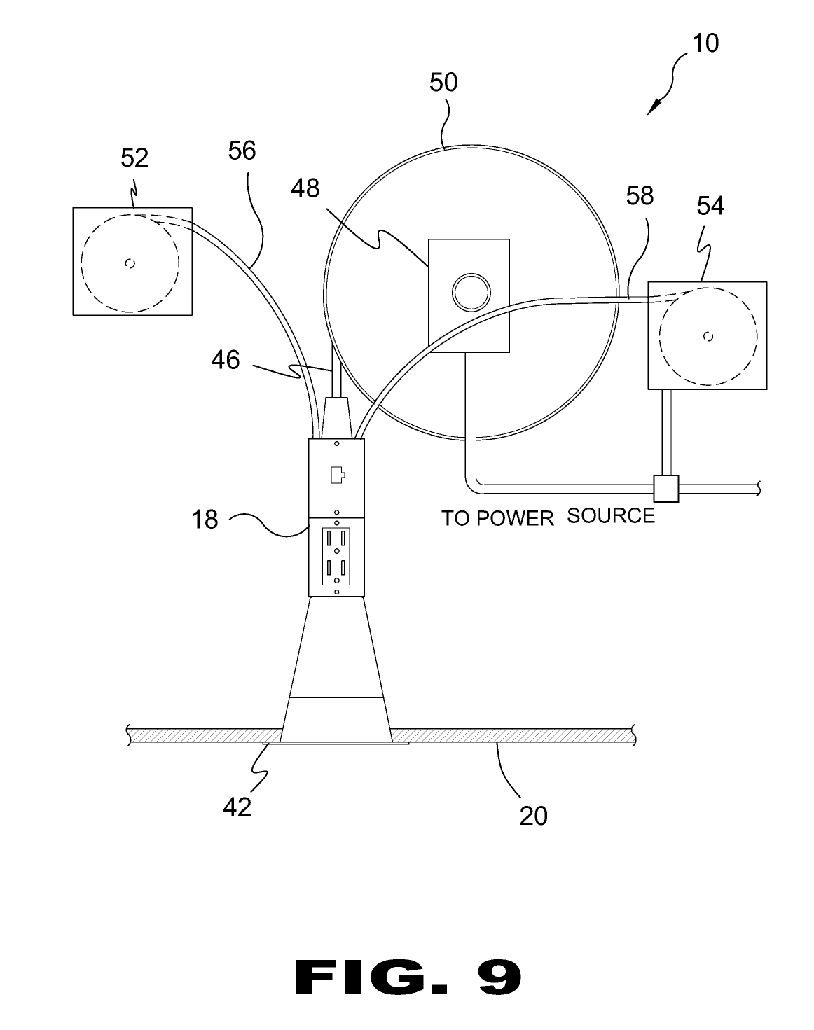

FIG. 9 is an illustrative view of the ceiling deployable electric and data ports module system 10 of the present invention with the module housing 18 in the retracted stored position. Shown is the motorized central cable 46 on its motor 48 operated spool 50 and the data/network feeder cable 56 on the data/network spring tensioned spool 52 and the electrical feeder line 58 wound onto the electrical spring tensioned spool 54. The central cable 46 is load bearing and is in control of raising and lowering the module housing 18 while the spring tensioned spools are to take up any additional slack in the connected data and electrical lines. Also depicted is the ceiling plate 42 sitting flush against the underside of said drop ceiling 20.

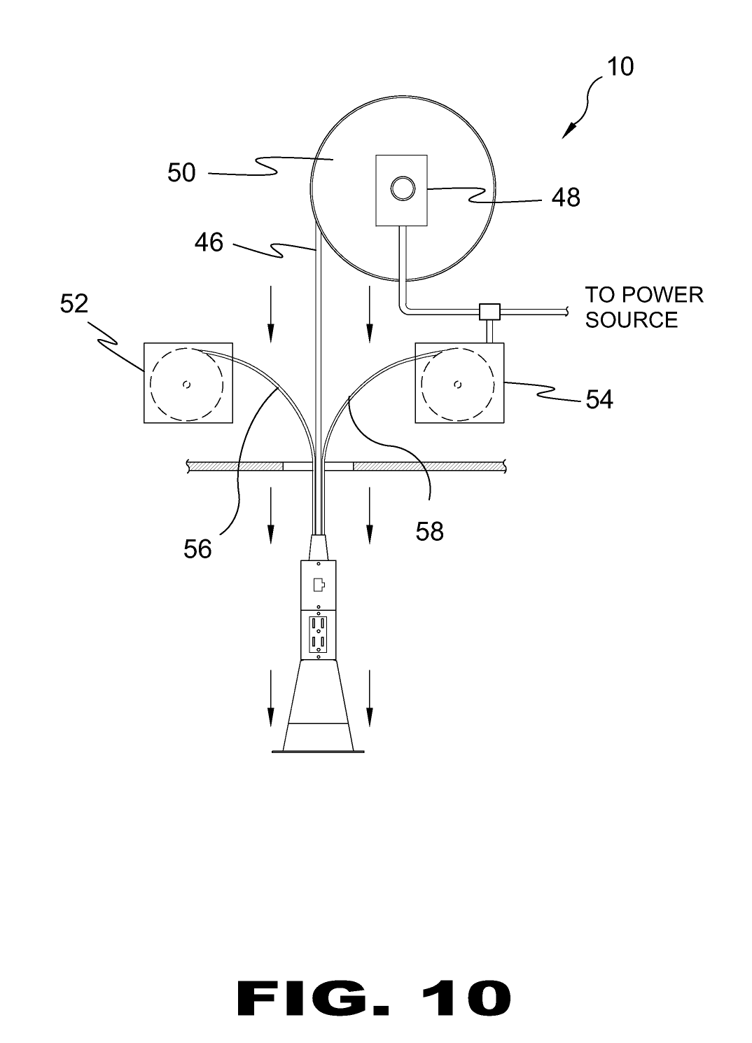

FIG. 10 is an illustrative view of the ceiling deployable electric and data ports module system 10 of the present invention with said module housing 18 being deployed. Shown is the motorized central cable 46 being lowered by its motor 48 operated spool 50 and the data/network feeder cable 56 on the data/network spring tensioned spool 52 and the electrical feeder line 58 on the electrical spring tensioned spool 54 unwinding.

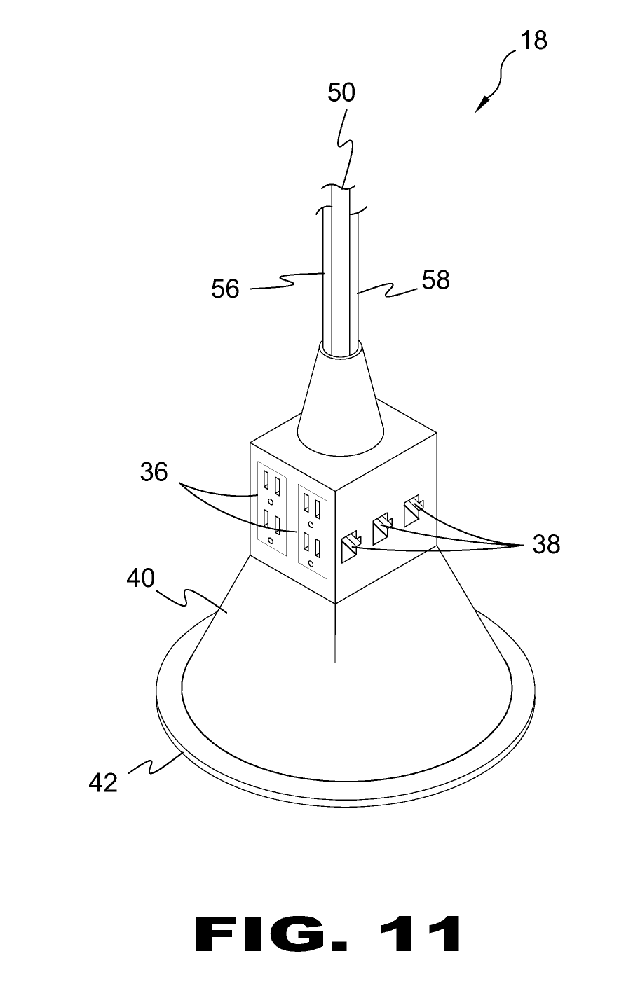

FIG. 11 is a perspective view of an additional element of the module housing 18. Shown is an additional element of the power/network module 18 having a plurality of power receptacles 36 data/network ports 38. Also shown are the steel central cable 50, data/network feeder cable 56, electrical feeder line 58, weighted housing base 40 and ceiling plate 42 which doubles as a stand when seated on a structure.

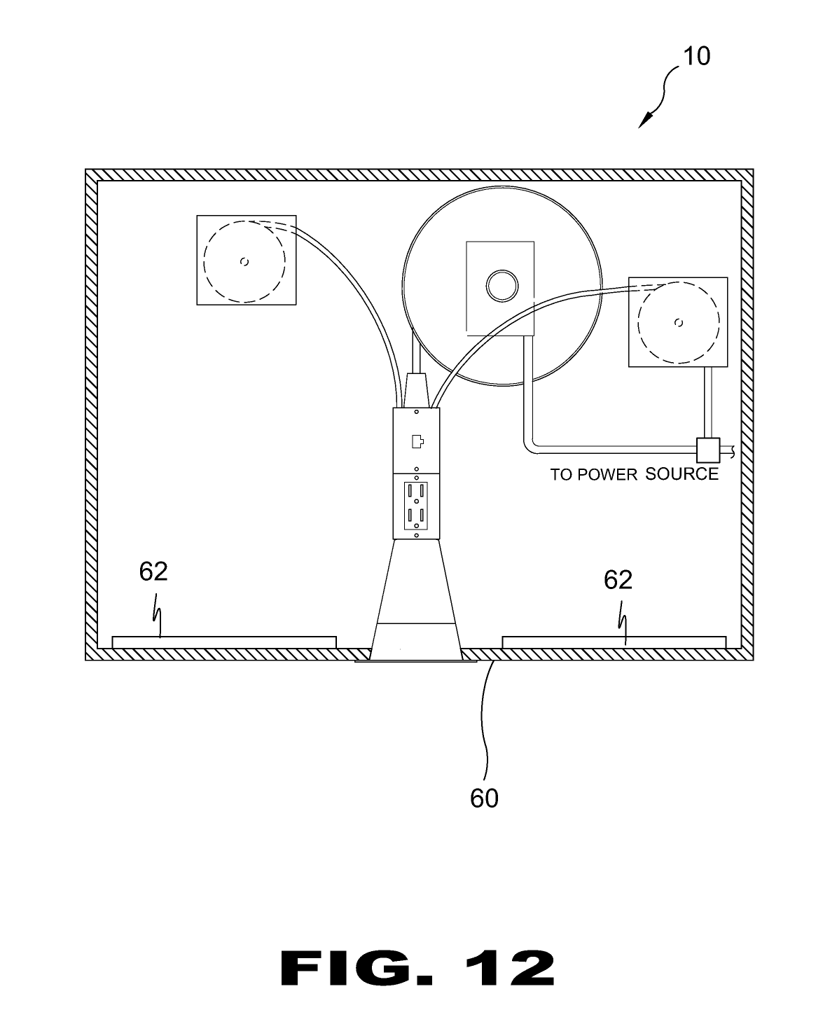

FIG. 12 is a sectional view of an embodiment of the power network module housing system 10 of the present invention. Shown is the system installed in a fixed ceiling 60 with spreader bars 62 on the top side thereof to provide additional support.

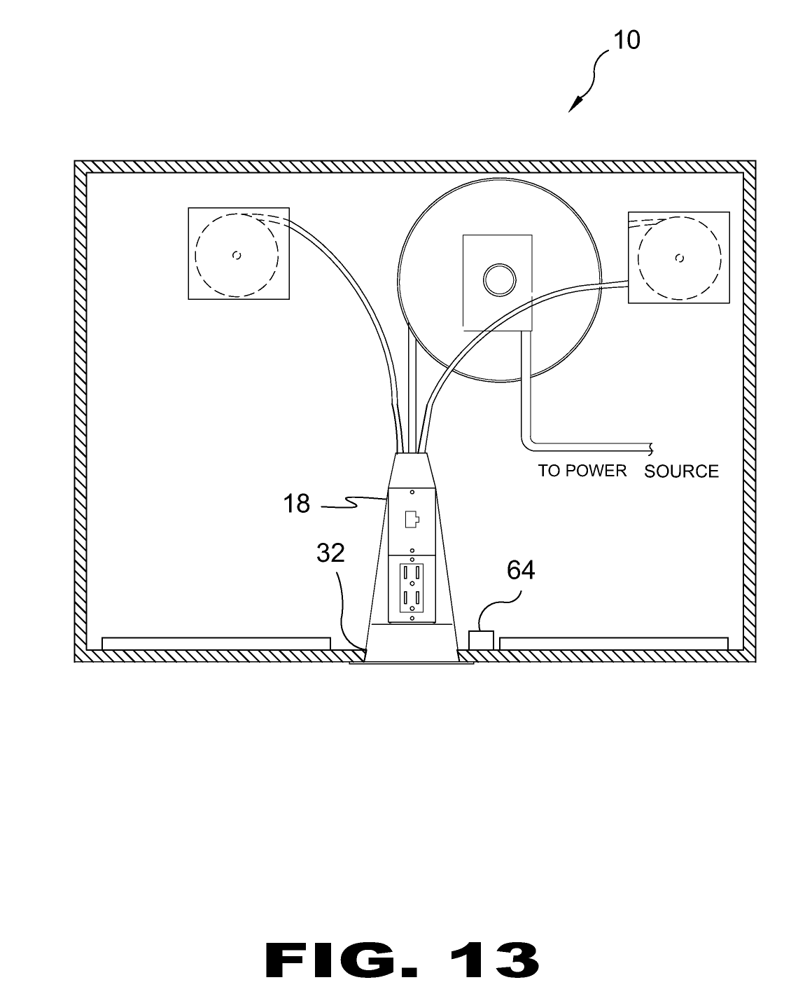

FIG. 13 is a sectional view of an additional element of the present invention. Shown is the power network module housing system 10 including a sensor 64 in electrical communication with said motor 48 mounted approximate the housing module aperture 32 used to shut off the rewind spool motor 48 when the module housing 18 enters therein.

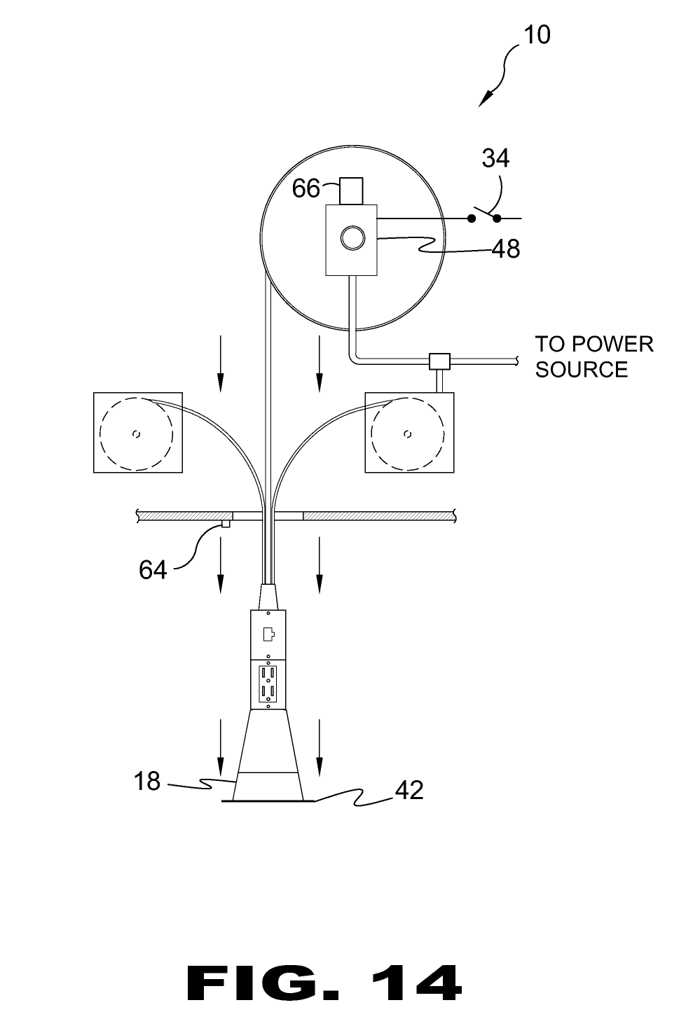

FIG. 14 is an illustrative view of the power/network components of the power network module housing system 10 in use. Shown is the motor 48 having a receiver 66 in wireless communication with the remote control unit and the key switch 34 for initiating and terminating the raising and lowering of the power/network module 18. Also shown is the kill switch 64 released by the removal of the ceiling plate 42 thereagainst.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A ceiling deployable electric and data/network port module system for remotely lowering and raising a module housing having electric and data/network ports to and from a concealed position in a ceiling comprising:
a) a module housing having a base, a central portion and a top side;
b) a reversible motor disposed in said ceiling;
c) a cable bundle extending through said top side of said module housing having a load bearing central pliable steel cable leading to a central steel cable spool driven by said reversible motor;
d) at least one electrical receptacle disposed in said central portion of said module housing;
e) at least one data/network/peripheral port disposed in said central portion of said module housing; and
f) at least one remote means for activating and deactivating said motor.

2. The ceiling deployable electric and data/network port module system according to claim 1, wherein said cable bundle further comprises an electric feeder line to supply power to said at least one electrical receptacle.

3. The ceiling deployable electric and data/network port module system according to claim 1, wherein said cable bundle further comprises a data/network feeder cable to provide internet and networking capabilities to said at least one data/network port.

4. The ceiling deployable electric and data/network port module system according to claim 2, wherein said electric feeder line extends from the interior of said module housing to an electric feeder line spring tension spool disposed in said ceiling to prevent the line from developing slack during use.

5. The ceiling deployable electric and data/network port module system according to claim 3, wherein said data/networking feeder cable extends from the interior of said module housing to a data/networking feeder cable to a spring tension spool disposed in said ceiling to prevent the cable from developing slack during use.

6. The ceiling deployable electric and data/network port module system according to claim 3, wherein said cable bundle travels through an aperture disposed in said ceiling.

7. The ceiling deployable electric and data/network port module system according to claim 6, wherein said at least one remote device is selected from the group of a wireless hand held remote control that sends a signal to a receiver on said motor and a key switch that operates an electrical switch leading to said motor.

8. The ceiling deployable electric and data/network port module system according to claim 7, wherein activation of said reversible motor initiates the unspooling of said central steel cable wherein the descent of said module housing is gravity fed.

9. The ceiling deployable electric and data/network port module system according to claim 8, wherein the downward bias created by the descent of said housing module unspools said electric line feeder line and said data/networking feeder cable from their respective spring tension spools to follow said module housing and store the kinetic energy created by the rotation thereof in the spring tension spools.

10. The ceiling deployable electric and data/network port module system according to claim 9, wherein reversing and activating said motor with said remote device retracts said module housing via said central steel cable and then said electric feeder line and said data/network feeder lines follow due to the stored kinetic energy in their respective spools being released.

11. The ceiling deployable electric and data/network port module system according to claim 1, wherein said base of said module housing is weighted to provide a stable stand for said housing when in the deployed position.

12. The ceiling deployable electric and data/network port module system according to claim 1, further comprising a ceiling plate on the bottom of said module housing assuming the appearance of a typical high hat for aesthetic purposes.

13. The ceiling deployable electric and data/network port module system according to claim 10, further comprising a sensor disposed on the top surface of said ceiling to detect the entry of said module housing through said ceiling aperture upon retraction therein and de-energize the motor.

14. The ceiling deployable electric and data/network port module system according to claim 10, including a kill switch disposed on the underside of said ceiling proximal to said aperture to de-energize said reversible motor upon contact of said ceiling plate therewith.

15. The ceiling deployable electric and data/network port module system according to claim 14, wherein said reversible motor is a variable speed motor.

16. The ceiling deployable electric and data/network port module system according to claim 15, whereupon detection of said module housing by said sensor into said ceiling communicates with said motor to decrease the rate of ascent of said module housing.

17. The ceiling deployable electric and data/network port module system according to claim 16, wherein the decreased rate of ascent of said module housing provides for gentle contact of said kill switch to de-energize said motor and smoothly park said module housing in the concealed, stored position.

18. The ceiling deployable electric and data/network port module system according to claim 1, wherein the system may be utilized with suspended drop ceilings and fixed ceilings.

19. The ceiling deployable electric and data/network port module system according to claim 18, wherein a plurality of spreader bars are disposed on the top side of said ceiling proximal said ceiling aperture to provide additional support for the ceiling.

20. The ceiling deployable electric and data/network port module system according to claim 1, wherein the pliability of said central cable enables the user to select the lateral placement of said module housing on the surface on which id resides.
